(19) United States
(12) Patent Application Publication
(10) Pub. No.: US 2022/0417855 A1
(43) Pub. Date: Dec. 29, 2022

(54) Connectivity Offload For Power Saving

(71) Applicant: META PLATFORMS TECHNOLOGIES, LLC, Menlo Park, CA (US)

(72) Inventors: Amit Shukla, Fremont, CA (US); Gang Lu, Pleasanton, CA (US)

(21) Appl. No.: 17/710,115

(22) Filed: Mar. 31, 2022

Related U.S. Application Data
(60) Provisional application No. 63/214,204, filed on Jun. 23, 2021.

(51) Int. Cl. H04W 52/02; H04W 52/46; H04W 76/15; H04W 76/27

(52) U.S. Cl. CPC H04W 52/0235; H04W 52/46; H04W 76/15; H04W 76/27

(57) ABSTRACT

In one embodiment, a method by a first processing module of a device includes establishing a connectivity to a network device through a second processing module of the device having a network device driver, running a first process associated with an application on the first processing module, where the first process establishes a first communication session with an external system for the application through the network device driver of the second processing module, sending, in response to a determination that a condition for a communication offloading is satisfied, a first instruction to the second processing module to cause the second processing module to run a second process associated with the application on the second processing module, where the second process establishes a second communication session with the external system for the application, and entering into an idle mode.

### PRIORITY

This application claims the benefit under 35 U.S.C. § 119(e) of U.S. Provisional Patent Application No. 63/214,204, filed 23 Jun. 2021, which is incorporated herein by reference.

### TECHNICAL FIELD

This disclosure generally relates to communication devices, and in particular, related to power saving techniques in communication devices.

### BACKGROUND

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments described herein relate to systems and methods for reducing power consumptions of a battery-powered device by offloading wireless interface management to a microcontroller unit (MCU). A wearable system may be an example of a battery-powered device. A typical wearable system may comprise a system on a chip (SoC), a connectivity sub-system running wireless modems, and a low-power MCU. The SoC may consume considerable amount of power. The SoC may try to reduce power consumptions by entering into a sleep mode when the SoC does not need to be active. When an event requiring the SoC's attention occurs, the SoC may enter into an active mode. In legacy battery-powered devices, the SoC may manage the wireless interfaces, which may prevent the SoC from being in the sleep mode for a longer period of time. The invention disclosed herein allows a battery-powered device to offload workload associated with wireless communications to a low power MCU.

In particular embodiments, a first processing module of a device may establish a connectivity to a network device through a second processing module of the device having a network device driver. In particular embodiments, the first processing module may be a system on a chip (SoC) comprising one or more processor cores. The second processing module may be a microcontroller unit (MCU). The network device may be a wireless access point or a base station. The first processing module may be associated with a first Media Access Control (MAC) address. The first processing module may be associated with a first Internet Protocol (IP) address. The first processing module forwards outgoing messages to the second processing module using an inter-process communication (IPC) mechanism. The IPC mechanism may comprise a shared memory. The network device driver located in the second processing module may send out the forwarded outgoing message to the network device upon receiving a forwarded outgoing message. When an incoming message arrives, the network device driver located on the second processing module may determine whether the incoming message is destined to the first processing module based on a destination MAC address of the incoming message. The network device driver on the second processing module may forward an incoming message to the first processing module using an IPC mechanism when the network device driver on the second processing module determines that the incoming message is destined to the first processing module. The first processing module may comprise a thin network driver handling control plane services. The first processing module may run a first process associated with an application on the first processing module. The first process may establish a first communication session with an external system for the application through the network device driver of the second processing module. The external system may send messages to the first IP address when the external system communicates with the first processing module through the first communication session.

In particular embodiments, the first processing module may determine that a condition for a communication offloading is satisfied. The condition for the communication offloading may comprise (1) that message exchanges with the external system are expected to be less than a pre-determined threshold frequency, (2) that accessing peripheral devices for communicating with the external system is expected to be less than a pre-determined threshold rate, wherein the peripheral devices comprise dynamic random-access memory (DRAM), or any suitable condition for a communication offloading. In response to the determination, the first processing module may send a first instruction to the second processing module. The first instruction may cause the second processing module to run a second process associated with the application on the second processing module. The second process may establish a second communication session with the external system for the application. The second processing module may be associated with a second MAC address that is different from the first MAC address. The second processing module may be associated with a second IP address. In particular embodiments, the first processing module may send a notification to the external system indicating that the communication offloading is activated. The external system communicates with the second processing module during the communication offloading. The second processing module may process an incoming message when the second processing module determines that the incoming message is destined to the second processing module. The external system may send messages to the second IP address when the external system communicates with the second processing module through the second communication session during the communication offloading. The first processing module may enter into an idle mode.

In particular embodiments, the first processing module may receive a system interrupt causing the first processing module to enter into an active mode from the idle mode. In particular embodiments, the system interrupt may be caused by the second processing module when the second processing module determines that a condition to wake up the first processing module is satisfied. The condition to wake up the first processing module may comprise (1) an incoming message is determined to be destined to the first processing module, (2) a control plane issue associated with the connectivity to the network device is detected, or any suitable condition to wake up the first processing module. In particular embodiments, the system interrupt may be caused by a hardware mailbox associated with the IPC mechanism when the hardware mailbox receives a message destined to the first processing module from the second processing module. The message may be either a control plane message or a user plane message. The first processing module may send a second instruction to the second processing module. The second instruction may cause the second processing module to end the communication offloading. The first processing module may perform tasks associated with the system interrupt.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example logical architecture of a battery-powered mobile device.

FIG. 2 illustrates an example communication system architecture for a mobile device.

FIG. 3 illustrates an example sequence for starting a communication offloading.

FIG. 4 illustrates an example method for activating a communication offloading to reduce power consumption.

FIG. 5 illustrates an example computer system.

### DESCRIPTION OF EXAMPLE EMBODIMENTS

Particular embodiments described herein relate to systems and methods for reducing power consumptions of a battery-powered device by offloading wireless interface management to an MCU. A wearable system may be an example of a battery-powered device. A typical wearable system may comprise an SoC, a connectivity sub-system running wireless modems, and a low-power MCU. The SoC may consume considerable amount of power. The SoC may try to reduce power consumptions by entering into a sleep mode when the SoC does not need to be active. When an event requiring the SoC's attention occurs, the SoC may enter into an active mode. In legacy battery-powered devices, the SoC may manage the wireless interfaces, which may prevent the SoC from being in the sleep mode for a longer period of time. The invention disclosed herein allows a battery-powered device to offload workload associated with wireless communications to a low power MCU.

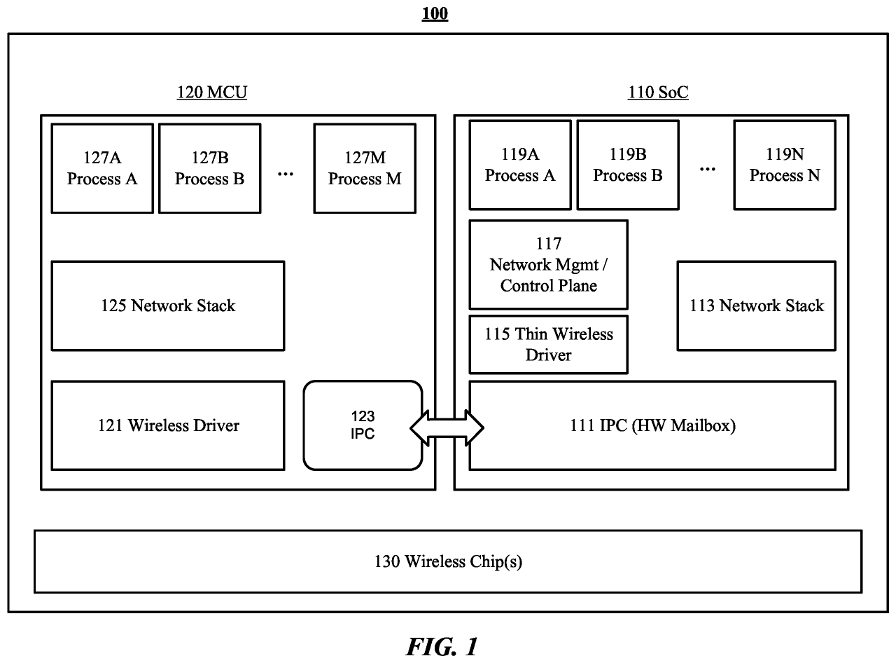

FIG. 1 illustrates an example logical architecture of a battery-powered mobile device 100. The battery-powered mobile device 100 may comprise an SoC 110, a low-power MCU 120, and one or more wireless chips 130. The SoC 110 may comprise one or more processor cores. The SoC 110 may access dynamic random-access memory (DRAM) and one or more secondary storages. An IPC module 111 within the SoC 110 may communicate with an IPC module 123 of the MCU over an IPC channel. The IPC channel may comprise a shared memory. The SoC 110 may comprise network stack 113 handling layer-2 and above and one or more active processes 119A, 119B, . . . , and 119N for applications running on the battery-powered mobile device 100. The SoC 110 may comprise a thin wireless device driver 115 for network management and control plane services. The network management/control plane module 117 may perform tasks associated with control plane services. The MCU 120 may comprise one or more processor cores. The MCU 120 may access static random-access memory (SRAM) and programmable input/output peripherals. In a legacy mobile device, an MCU is used as a co-processor for functions such as the capacitive touch-sensing interface, touch screen interface, camera interface, detecting different analog sensor inputs, USB interface, and battery charging and monitoring. In the mobile device 100 illustrated in FIG. 1, the MCU 120 may also be used for wireless traffic offloading in addition to the above-mentioned functions. The MCU 120 may comprise a wireless device driver 121. The MCU 120 may also comprise a network stack 125 and one or more active processes 127A, 127B, . . . , and 127M. The one or more active processes 127A, 127B, . . . , and 127M may handle wireless traffic for the applications during a traffic offloading. Although this disclosure describes a particular logical architecture for a battery-powered mobile device, this disclosure contemplates any suitable logical architecture for a battery-powered mobile device.

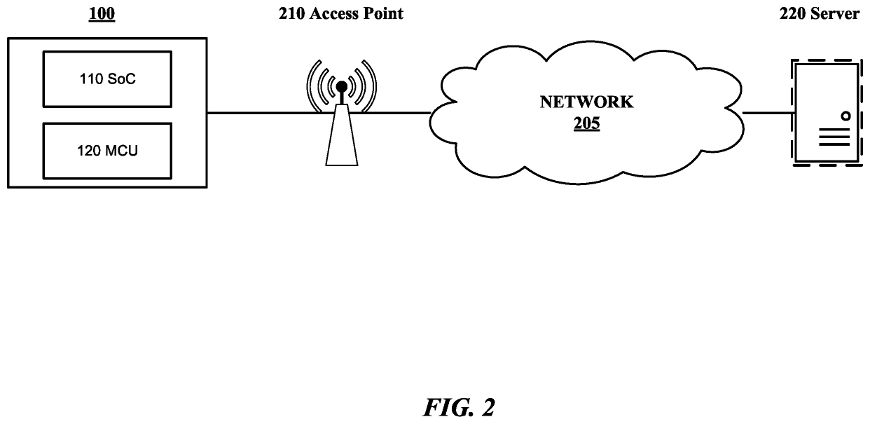

In particular embodiments, a first processing module of a device may establish a connectivity to a network device through a second processing module of the device having a network device driver. In particular embodiments, the first processing module may be a system on a chip (SoC) comprising one or more processor cores. The second processing module may be a microcontroller unit (MCU). The second processing module may consume considerably less power than the first processing module. The network device may be a wireless access point or a base station. In particular embodiments, the first processing module may be associated with a first Media Access Control (MAC) address. The first processing module may be associated with a first Internet Protocol (IP) address. By establishing a connectivity to the network device, the device may access the network. In particular embodiments, the network may be a wireless network connected to the Internet. FIG. 2 illustrates an example communication system architecture for a mobile device. As an example and not by way of limitation, The SoC 110 of the mobile device 100 may establish a connectivity to a wireless access point 210. The communication messages for the SoC 110 may go through a wireless device driver 121 located on the MCU 120. Upon completion of the establishing the connectivity, the mobile device 100 may access the wireless network. The wireless access point 210 may be connected to a network 205. Thus, the mobile device 100 may be able to communicate with a remote server 220. The SoC 110 is associated with a first MAC address. In particular embodiments, the SoC 110 is associated with a first IP address. When the SoC 110 exchanges messages with the server 220, the server 220 sends messages to the first IP address. The wireless access point 210 may perform an Address Resolution Protocol (ARP) lookup to map the first IP address to the first MAC address. The wireless access point 210 forwards the messages destined to the first IP address to the mobile device 100. The destination MAC address of the messages may be the first MAC address. Although this disclosure describes establishing a network connectivity by an SoC of a mobile device in a particular manner, this disclosure contemplates establishing a network connectivity by an SoC of a mobile device in any suitable manner.

In particular embodiments, the first processing module forwards outgoing messages to the second processing module using an IPC mechanism. The IPC mechanism may comprise a shared memory. The network device driver located in the second processing module may send out the forwarded outgoing message to the network device upon receiving a forwarded outgoing message. As an example and not by way of limitation, the SoC 110 may send a message to the wireless access point 210. A source MAC address of the message may be the first MAC address. A source IP address of the message may be the first IP address. The SoC 110 may forward the message to the MCU 120 through the IPC channel. The wireless device driver 121 on the MCU 120 may forward the message to the wireless access point 210 through the wireless chip 130. Although this disclosure describes the first processing module's sending out messages in a particular manner, this disclosure contemplates the first processing module's sending out messages in any suitable manner.

In particular embodiments, the network device driver located on the second processing module may determine whether an incoming message is destined to the first processing module based on a destination MAC address of the incoming message. The network device driver on the second processing module may forward an incoming message to the first processing module using an IPC mechanism when the network device driver on the second processing module determines that the incoming message is destined to the first processing module. As an example and not by way of limitation, a message destined to the SoC 110 arrives at the mobile device 100. The wireless device driver 121 on the MCU 120 determines that the recipient of the message is the SoC 110 based on a destination MAC address of the message. The wireless device driver 121 forward the message to the SoC 110 through an IPC channel. The IPC module 123 on the MCU handles the IPC communication. When the message arrives at the IPC module 111 of the SoC 110, the message goes through the network stack 113. One of the processes 119A, 119B, . . . , and 119N may receive the payload of the message. Although this disclosure describes delivering an incoming message destined to the first processing module by the network device driver in a particular manner, this disclosure contemplates delivering an incoming message destined to the first processing module by the network device driver in any suitable manner.

In particular embodiments, the first processing module may comprise a thin network driver handling control plane services. The control plane services may comprise a wireless supplicant, a host access point deamon (hostapd), or a cfg80211 subsystem. As an example and not by way of limitation, network management/control plane services may require access to information stored in the memory. Thus, the network management/control plane service may need to be handled by the SoC 110. The network management/control plane module 117 performs tasks associated with network management/control plane services. The SoC 110 may have a thin wireless device driver 115 for handling the network management/control plane services. Although this disclosure describes handling network management/control plane services by the first processing module in a particular manner, this disclosure contemplates handling network management/control plane services by the first processing module in any suitable manner.

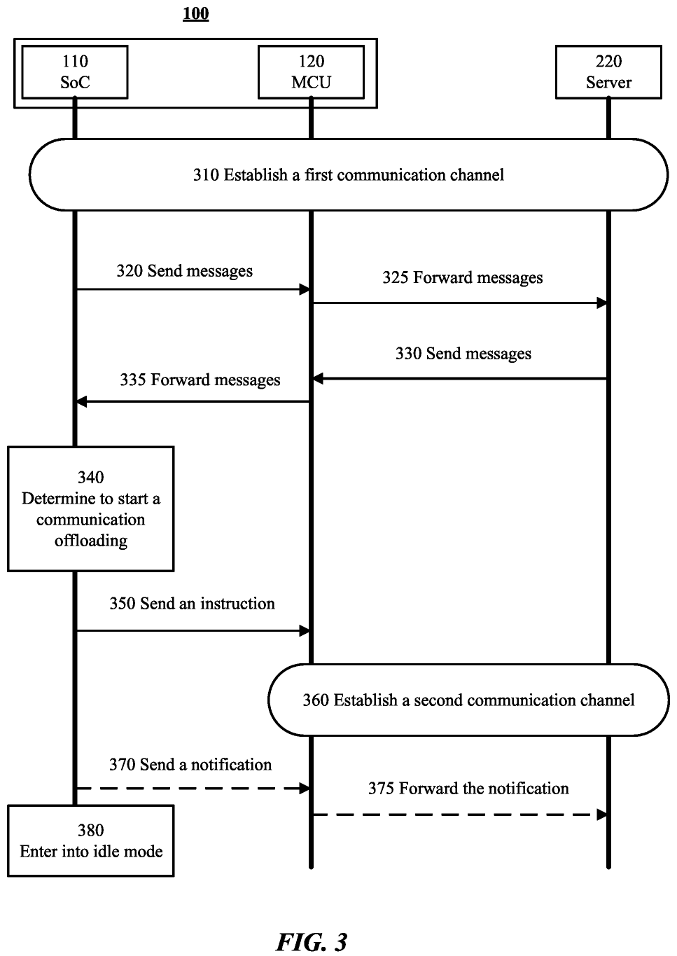

In particular embodiments, the first processing module may run a first process associated with an application on the first processing module. The first process may establish a first communication session with an external system for the application through the network device driver of the second processing module. The external system may send messages to the first IP address when the external system communicates with the first processing module through the first communication session. FIG. 3 illustrates an example sequence for starting a communication offloading. As an example and not by way of limitation, after the SoC 110 establishes a connectivity to the wireless access point 210, the SoC 110 may initiate a process for an application on the SoC 110. The process for the application may be automatically initiated as a part of scheduled tasks. In particular embodiments, the process for the application may be initiated based on a user input. Examples of the application include, but not limited to, a messenger application, an email client application, or a music streaming application. In many cases, the application may need to communicate with one or more external systems, such as one or more servers or one or more peer devices. At step 310, the SoC 110 may establish a communication session with a server 220. Though the example illustrated in FIG. 3 shows establishing a communication session with a server, the SoC 110 may establish a communication session with any suitable external system. To establish the communication session with the server 220, the SoC 110 may need to exchange a series of messages with the server 220. The messages go through the wireless device driver 121 on the MCU 120. Examples of the communication session includes, but not limited to, a Transport Control Protocol (TCP) connection between the IP address of the SoC 110 and an IP address of the server 220, or an application level communication session over User Datagram Protocol (UDP). For the UDP communications, the server 220 sends messages to the SoC 110 using the IP address of the SoC 110 as a destination IP address. After establishing the communication session, the SoC 110 may send payload messages to the server at step 320. The payload messages are forwarded by the wireless device driver 121 on the MCU 120 at step 325. The server 220 may also send payload messages to the SoC 110 at step 330. When the payload messages from the server 220 are routed to the wireless access point 210, the wireless access point 210 adds a MAC header to the payload messages and forward the messages over the wireless network. Upon receiving the messages over the wireless network, the wireless device driver 121 on the MCU 120 determines that the messages belong to the SoC 110 based on the destination MAC address. At step 335, the wireless device driver 121 forward the messages to the SoC 110 using an IPC mechanism. Although this disclosure describes establishing a communication session with a server and exchanging payload messages with the server in a particular manner, this disclosure contemplates establishing a communication session with a server and exchanging payload messages with the server in any suitable manner.

In particular embodiments, the first processing module may determine that a condition for a communication offloading is satisfied. The condition for the communication offloading may comprise (1) that message exchanges with the external system are expected to be less than a pre-determined threshold frequency, (2) that accessing peripheral devices for communicating with the external system is expected to be less than a pre-determined threshold rate, wherein the peripheral devices comprise dynamic random-access memory (DRAM), or any suitable condition for a communication offloading. As an example and not by way of limitation, the SoC 110, at step 340, determines that a condition for a communication offloading is satisfied by observing that the user is not actively involved in exchanging messages on a messenger application for a pre-determined amount of time. The messenger application only exchanges infrequent heart-beat messages with the server 220. The SoC 110 may get into an idle mode to reduce power consumption while the MCU 120 is in charge of responding to heart-beat requests from the server 220. As another example and not by way of limitation, The SoC 110, at step 340, determines that a condition for a communication offloading is satisfied by observing that the only actively communicating application is a music streaming application. The music streaming application receives payload from the server 220 and plays the received music to a speaker associated with the mobile device 100, which only requires accessing an I/O bus, but does not require accessing DRAM. Thus, the MCU 120 may handle the music streaming application without getting the SoC 110 involved. Although this disclosure describes determining that a condition for a communication offloading is satisfied in a particular manner, this disclosure contemplates determining that a condition for a communication offloading is satisfied in any suitable manner.

In particular embodiments, the first processing module may send a first instruction to the second processing module in response to the determination that a condition for a communication offloading is satisfied. The first instruction may cause the second processing module to run a second process associated with the application on the second processing module. The second process may establish a second communication session with the external system for the application. The second processing module may be associated with a second MAC address that is different from the first MAC address. The second processing module may be associated with a second IP address. As an example and not by way of limitation, continuing with a prior messenger application example, at step 350, the SoC 110 sends a signal to the MCU 120 to cause the MCU 120 to run a process for the messenger application. The MCU 120 is associated with its own MAC address, which is different from the MAC address of the SoC 110. In particular embodiments, the MCU 120 may be associated with its own IP address, which is different from the IP address of the SoC 110. On receiving the signal from the SoC 110, the MCU 120 launch a process for the messenger application. The process, at step 360, may establish a new communication session with the server 220. In particular embodiments, the server 220 may send messages to the IP address of the MCU 120 over the new communication session. Although this disclosure describes sending an instructions to the second processing module to run a process for the application and to establish a communication session with the external system in a particular manner, this disclosure contemplates sending an instructions to the second processing module to run a process for the application and to establish a communication session with the external system in any suitable manner.

In particular embodiments, the first processing module may send a notification to the external system indicating that the communication offloading is activated. The external system communicates with the second processing module during the communication offloading. The external system may send messages to the second IP address when the external system communicates with the second processing module through the second communication session during the communication offloading. As an example and not by way of limitation, the SoC 110, at step 370, may send a notification to the server 220 indicating that a communication offloading is started and that the communication session between the MCU 120 and the server 220 is to be used for the upcoming communications. At step 375, the MCU 120 forwards the notification to the server 220. In another embodiment, the MCU 120 may send the notification to the server 220 after establishing the new communication session. Yet in another embodiment, establishing the new communication session between the MCU 120 and the server 220 may be considered by the server 220 as an indication of the communication offloading. Although this disclosure describes sending a notification indicating that a communication offloading is started in a particular manner, this disclosure contemplates sending a notification indicating that a communication offloading is started in any suitable manner.

In particular embodiments, the second processing module may process an incoming message when the second processing module determines that the incoming message is destined to the second processing module. As an example and not by way of limitation, continuing with a prior messenger example, the MCU 120 may receive a heart-beat request from the server 220. The wireless device driver 121 on the MCU 120 determines that the heart-beat request is destined to the MCU 120 based on the destination MAC address of the message. The heart-beat request message goes through the network stack 125. The process for the messenger application running on the MCU 120 receives the heart-beat request and sends out a heat-beat response to the server 220. Although this disclosure describes handling of incoming messages by the second processing module during a communication offloading in a particular manner, this disclosure contemplates handling of incoming messages by the second processing module during a communication offloading in any suitable manner.

In particular embodiments, the first processing module may enter into an idle mode. As an example and not by way of limitation, at step 380, the SoC 110 enters into an idle mode. In the idle mode, the SoC 110 may consume significantly reduced amount of power. As the MCU 120 is required to be active all the time, the power consumption of the MCU 120 during the communication offloading is not more than the power consumption of the MCU 120 at the other duration. Although this disclosure describes entering into an idle mode when a communication offloading is started in a particular manner, this disclosure contemplates entering into an idle mode when a communication offloading is started in any suitable manner.

In particular embodiments, the first processing module may receive a system interrupt causing the first processing module to enter into an active mode from the idle mode. In particular embodiments, the first processing module may receive any suitable signal causing the first processing module to enter into the active mode from the idle mode. After entering into the active mode, the first processing module may end the communication offloading. As an example and not by way of limitation, the SoC 110 receives a system interrupt while the SoC 110 is in the idle mode. The SoC 110 enters into an active mode. Although this disclosure describes receiving a signal causing the first processing module to enter into an active mode from an idle mode in a particular manner, this disclosure contemplates receiving a signal causing the first processing module to enter into an active mode from an idle mode in any suitable manner.

In particular embodiments, the system interrupt may be caused by the second processing module when the second processing module determines that a condition to wake up the first processing module is satisfied. The condition to wake up the first processing module may comprise an incoming message is determined to be destined to the first processing module, a control plane issue associated with the connectivity to the network device is detected, or any suitable condition. In particular embodiments, the second processing module may cause any suitable signaling to wake up the first processing module from the idle model in response to the determination. As an example and not by way of limitation, the wireless device driver 121 on the MCU 120 may, while the communication offloading is active, receive an incoming message and determine that the message is destined to the SoC 110 based on the destination MAC address. The MCU 120 may cause a system interrupt that wakes up the SoC 110 from the idle mode. As another example and not by way of limitation, a process on the MCU 120 may, while the communication offloading is active, determine that processing the on-going communications may require to access resources that the MCU 120 cannot directly access. The resources include, but not limited to DRAM, secondary storage, or any suitable resources. The MCU 120 may cause a system interrupt that wakes up the SoC 110 from the idle mode. As yet another example and not by way of limitation, the wireless device driver 121 on the MCU 120 may, while the communication offloading is active, determine that an event associated with one or more control plane services occurs. The event includes, but not limited to, receiving a control plane message from the wireless access point 210, losing the connectivity to the wireless access point 210, or any suitable event. The MCU 120 may cause a system interrupt that wakes up the SoC 110 from the idle mode. Although this disclosure describes causing a system interrupt that wakes up the first processing module from an idle mode by the second processing module in a particular manner, this disclosure contemplates causing a system interrupt that wakes up the first processing module from an idle mode by the second processing module in any suitable manner.

In particular embodiments, the system interrupt may be caused by a hardware mailbox associated with the IPC mechanism when the hardware mailbox receives a message destined to the first processing module from the second processing module. In particular embodiments, the system interrupt may be caused by any suitable hardware component. The message may be either a control plane message or a user plane message. As an example and not by way of limitation, when the MCU 120 determines that a condition to wake up the SoC 110 is satisfied, the MCU 120 may send a message to the SoC 110 using the IPC channel. On receiving the message, the hardware mailbox associated with the IPC module 111 on the SoC 110 may cause a system interrupt that wakes up the SoC 110 from the idle mode. Although this disclosure describes causing a system interrupt that wakes up the first processing module from an idle mode by a hardware in a particular manner, this disclosure contemplates causing a system interrupt that wakes up the first processing module from an idle mode by a hardware in any suitable manner.

In particular embodiments, the first processing module may send a second instruction to the second processing module upon entering into the active mode from the idle mode. The second instruction may cause the second processing module to end the communication offloading. As an example and not by way of limitation, when the SoC 110 enters into an active mode from the idle mode, the SoC 110 may send an instruction to the MCU 120. The instruction may cause the process on the MCU 120 to finish up the communication session. In particular embodiments, the process on the MCU 120 and the server 220 may finish exchanging the cached messages before finishing up the communication session. In particular embodiments, the instruction may also cause the process on the MCU 120 to end. Although this disclosure describes sending an instruction to the second processing module to end the communication offloading in a particular manner, this disclosure contemplates sending an instruction to the second processing module to end the communication offloading in any suitable manner.

In particular embodiments, the first processing module may perform tasks associated with the system interrupt. As an example and not by way of limitation, the system interrupt may be associated with one or more incoming user plane message. A process on the SoC 110 may receive one or more incoming user plane messages. The process may handle the incoming user plane messages. In particular embodiments, the incoming user plane messages may require accessing resources on the mobile device 100. As another example and not by way of limitation, the system interrupt may be associated with control plane services. The network management/control plane module 117 may perform tasks associated with the control plane services through the thin wireless device driver 115. Although this disclosure describes performing tasks associated with the system interrupt in a particular manner, this disclosure contemplates performing tasks associated with the system interrupt in any suitable manner.

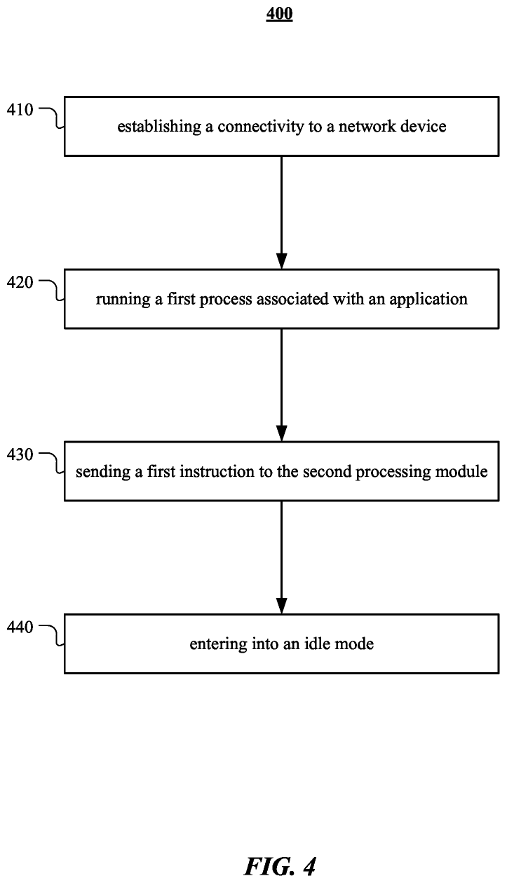

FIG. 4 illustrates an example method 400 for activating a communication offloading to reduce power consumption. The method may begin at step 410, where a first processing module may establish a connectivity to a network device through a second processing module of the device having a network device driver. At step 420, the first processing module may run a first process associated with an application on the first processing module. The first process may establish a first communication session with an external system for the application through the network device driver of the second processing module. At step 430, the first processing module may send a first instruction to the second processing module to cause the second processing module to run a second process associated with the application on the second processing module in response to a determination that a condition for a communication offloading is satisfied. The second process may establish a second communication session with the external system for the application. At step 440, the first processing module may enter into an idle mode. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for activating a communication offloading to reduce power consumption including the particular steps of the method of FIG. 4, this disclosure contemplates any suitable method for activating a communication offloading to reduce power consumption including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

### Systems and Methods

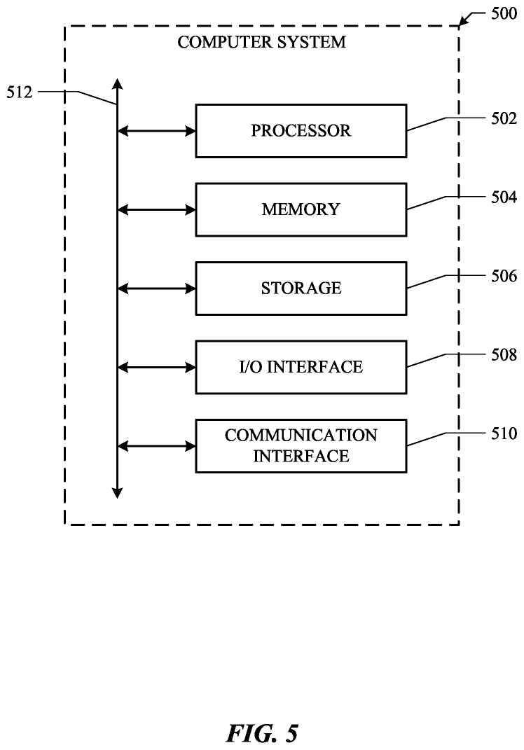

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by a first processing module of a device:
establishing a connectivity to a network device through a second processing module of the device having a network device driver;
running a first process associated with an application on the first processing module, wherein the first process establishes, through the network device driver of the second processing module, a first communication session with an external system for the application;
sending, in response to a determination that a condition for a communication offloading is satisfied, a first instruction to the second processing module to cause the second processing module to run a second process associated with the application on the second processing module, wherein the second process establishes a second communication session with the external system for the application; and
entering into an idle mode.

2. The method of claim 1, wherein the first processing module is associated with a first Media Access Control (MAC) address, and the second processing module is associated with a second MAC address that is different from the first MAC address.

3. The method of claim 2, wherein the second processing module, using the network device driver, determines whether an incoming message is destined to the first processing module based on a destination MAC address of the incoming message.

4. The method of claim 1, wherein the first processing module is associated with a first Internet Protocol (IP) address, and the second processing module is associated with a second IP address.

5. The method of claim 4, wherein the external system sends messages to the first IP address when the external system communicates with the first processing module through the first communication session, and wherein the external system sends messages to the second IP address when the external system communicates with the second processing module through the second communication session during the communication offloading.

6. The method of claim 1, further comprising:
sending a notification to the external system indicating that the communication offloading is activated, wherein the external system communicates with the second processing module during the communication offloading.

7. The method of claim 1, wherein the condition for the communication offloading comprises:
message exchanges with the external system are expected to be less than a pre-determined threshold frequency; or
accessing peripheral devices for communicating with the external system is expected to be less than a pre-determined threshold rate, wherein the peripheral devices comprise dynamic random-access memory (DRAM).

8. The method of claim 1, wherein the network device is a wireless access point or a base station.

9. The method of claim 1, wherein the first processing module is a system on a chip (SoC) comprising one or more processor cores, and wherein the second processing module is a microcontroller unit (MCU).

10. The method of claim 1, wherein the first processing module comprises a thin network driver handling control plane services.

11. The method of claim 10, wherein the control plane services comprise a wireless supplicant, a host access point deamon (hostapd), or a cfg80211 subsystem.

12. The method of claim 1, wherein the first processing module forwards outgoing messages to the second processing module using an inter-process communication (IPC) mechanism, and wherein the network device driver located in the second processing module, upon receiving a forwarded outgoing message, sends out the forwarded outgoing message to the network device.

13. The method of claim 1, wherein the second processing module forwards an incoming message to the first processing module using an IPC mechanism when the network device driver on the second processing module determines that the incoming message is destined to the first processing module.

14. The method of claim 1, wherein the second processing module processes an incoming message when the second processing module determines that the incoming message is destined to the second processing module.

15. The method of claim 1, further comprising:
receiving a system interrupt causing the first processing module to enter into an active mode from the idle mode;
sending, to the second processing module, a second instruction to cause the second processing module to end the communication offloading; and
performing tasks associated with the system interrupt.

16. The method of claim 15, wherein the system interrupt is caused by the second processing module when the second processing module determines that a condition to wake up the first processing module is satisfied.

17. The method of claim 16, wherein the condition to wake up the first processing module comprises:
an incoming message is determined to be destined to the first processing module; or
a control plane issue associated with the connectivity to the network device is detected.

18. The method of claim 15, wherein the system interrupt is caused by a hardware mailbox associated with the IPC mechanism when the hardware mailbox receives a message destined to the first processing module from the second processing module, wherein the message is either a control plane message or a user plane message.

19. One or more computer-readable non-transitory storage media embodying software that is operable when executed by a first processing module of a device to:
establish a connectivity to a network device through a second processing module of the device having a network device driver;
run a first process associated with an application on the first processing module, wherein the first process establishes, through the network device driver of the second processing module, a first communication session with an external system for the application;
send, in response to a determination that a condition for a communication offloading is satisfied, a first instruction to the second processing module to cause the second processing module to run a second process associated with the application on the second processing module, wherein the second process establishes a second communication session with the external system for the application; and
enter into an idle mode.

20. A device comprising:
a first processing module;
a second processing module; and
one or more computer-readable non-transitory storage media coupled to the first processing module and comprising instructions operable when executed by the first processing module to:
establish a connectivity to a network device through the second processing module of the device having a network device driver;
run a first process associated with an application on the first processing module, wherein the first process establishes, through the network device driver of the second processing module, a first communication session with an external system for the application;
send, in response to a determination that a condition for a communication offloading is satisfied, a first instruction to the second processing module to cause the second processing module to run a second process associated with the application on the second processing module, wherein the second process establishes a second communication session with the external system for the application; and
enter into an idle mode.
